(19) United States
(12) Patent Application Publication
(10) Pub. No.: US 2018/0066776 A1
(43) Pub. Date: Mar. 8, 2018

(54) Rotatable Pipe Adapter

(71) Applicant: John O. Roper, Fountain Inn, SC (US)

(72) Inventor: John O. Roper, Fountain Inn, SC (US)

(21) Appl. No.: 15/812,068

(22) Filed: Nov. 14, 2017

Related U.S. Application Data
(63) Continuation-in-part of application No. 15/255,321, filed on Sep. 2, 2016.
Application No. 15/255,321 is a continuation-in-part of application No. 15/166,466, filed on May 27, 2016.

(51) Int. Cl. F16L 21/02; F16L 9/12

(52) U.S. Cl. CPC F16L 21/02; F16L 9/12

(57) ABSTRACT

A pipe adapter includes a first tubular element having a first portion, a second portion axially adjacent the first portion, and a securing portion adjacent an end of the second portion opposite the first portion, the second portion defining a socket; a second tubular element having a first portion and a second portion axially adjacent the first portion, the first portion defining a distal end sized for insertion into the socket and having a radially extending stop; an annular sealing member. The securing portion is formed integrally with the second portion of the first tubular element and has a flange portion contacting the stop to secure the second tubular element axially relative to the first tubular element while also allowing the second tubular element to rotate relative to the first tubular element.

### CROSS-REFERENCE TO RELATED APPLICATIONS

The present application is a continuation-in-part application of and claims priority to co-pending U.S. patent application Ser. No. 15/166,466, filed May 27, 2016, and Ser. No. 15/255,321, filed Sep. 2, 2016, both of which are incorporated by reference herein.

### TECHNICAL FIELD

The present disclosure relates generally to an adapter for joining pipes, wherein the joined pipes are rotatable relative to one another after attachment to the adapter.

### BACKGROUND

Piping has been used to transmit liquids such as drinking water, waste water, irrigation water, fire sprinkler water, sewage, and chemicals to name but a few. Piping has also been used to transmit gases, and as a conduit for to holding electrical wiring. Often such piping is made of a plastic, such as Polyvinyl Chloride (PVC), Chlorinated Polyvinyl Chloride (CPVC), Acrylonitrile Butadiene Styrene (ABS), Polyethylene (PE), Cross-Linked Polyethylene (PEX), or others. Piping may be installed in an environment such as within a trench in the earth, within the walls or ceiling of a building, between two already fixed but not necessarily aligned external elements, etc. Due to the general rigidity of such piping, care must be taken to accurately design, lay out and connect piping. Because adjacent pieces of piping and their fittings are often connected permanently (e.g., via an epoxy or the like), a technician connecting such elements has little flexibility in installation path and only one chance to make each connection correctly. Further, in some situations, the intended installation environment differs from the planned layout, for example, if a trench is not accurately dug or is dug differently than planned due to rocks or other unforeseen subterranean impediments, if a building is not constructed exactly to plan or plans are changed after piping layout is completed, etc. Thus, for various reasons, it can be difficult and time consuming to develop and install various types of piping systems. Also, in seismic zones, rigid pipe connections are subject to failure in case of an earthquake.

Accordingly, improvements would be welcome to piping systems that provide more flexibility in creating a layout or to a technician during installation, more reliability in case of seismic activity and/or addressing one or more drawbacks of current systems, or any other issues.

### SUMMARY

According to certain aspects of the disclosure, a pipe adapter includes a first tubular element defining a central axis and having a first portion, a second portion axially adjacent the first portion, a securing portion adjacent an end of the second portion opposite the first portion, and a radially-extending shoulder between the first portion and second portion, the first portion having an inner diameter and an outer diameter, the second portion having an inner diameter larger than the first portion inner diameter and an outer diameter larger than the first portion inner diameter. A second tubular element defines a central axis and has a first portion and a second portion axially adjacent the first portion, the first portion of the second tubular element having an inner diameter and an outer diameter just smaller than the inner diameter of the second portion of the first tubular element, the second tubular element first portion having a distal end that abuts the shoulder and having a radially extending stop. An annular sealing member is located between the first portion of the second tubular element and the second portion of the first tubular element and providing an axial seal therebetween. The securing portion is formed integrally with the second portion of the first tubular element and has a flange portion contacting the stop to secure the second tubular element axially relative to the first tubular element while also allowing the second tubular element to rotate relative to the first tubular element. Various options and modifications are possible.

According to certain other aspects of the disclosure, a pipe adapter includes a first tubular element having a first portion, a second portion axially adjacent the first portion, and a securing portion adjacent an end of the second portion opposite the first portion, the second portion defining a socket. A second tubular element has a first portion and a second portion axially adjacent the first portion, the first portion defining a distal end sized for insertion into the socket and having a radially extending stop. An annular sealing member is located between the first portion of the second tubular element and the second portion of the first tubular element and providing an axial seal therebetween. The securing portion is formed integrally with the second portion of the first tubular element and has a flange portion contacting the stop to secure the second tubular element axially relative to the first tubular element while also allowing the second tubular element to rotate relative to the first tubular element. Various options and modifications are possible.

According to certain other aspects of the disclosure, a method of forming a pipe adapter includes placing into a holder a first tubular element having a first portion, a second portion axially adjacent the first portion, and a securing portion adjacent an end of the second portion opposite the first portion, the second portion defining a socket; placing an annular sealing member into a channel in one of the socket or a first end of a second tubular element; placing into the socket the second tubular element so that the annular sealing member provides an axial seal between the first and second tubular elements, the second tubular element having a second portion axially adjacent the first portion, the first portion defining a radially extending stop; and bending the securing portion so as to form a flange portion contacting the stop to secure the second tubular element axially relative to the first tubular element while also allowing the second tubular element to rotate relative to the first tubular element. Various options and modifications are possible.

### BRIEF DESCRIPTION OF THE DRAWINGS

More details of the present disclosure are set forth in the drawings.

FIG. 1 is an isometric view of a first embodiment of a pipe adapter according to certain aspects of the disclosure.

FIG. 2 is a side view of the pipe adapter of FIG. 1.

FIG. 3 is an end view of the pipe adapter of FIG. 1.

FIG. 4 is a cross-sectional view of the pipe adapter of FIG. 1 taken along line 4-4 in FIG. 1.

FIG. 5 is an exploded version of the cross-sectional view of FIG. 4.

FIG. 6 is a diagrammatic view showing possible connections to the pipe adapter of FIG. 1.

FIG. 7 is an isometric view of a second embodiment of a pipe adapter according to certain aspects of the disclosure.

FIG. 8 is a cross-sectional view of the pipe adapter of FIG. 7 taken along line 8-8 in FIG. 7.

FIG. 9 is an isometric view of another embodiment of a pipe adapter according to certain aspects of the disclosure.

FIG. 10 is a cross-sectional view of the pipe adapter of FIG. 9 taken along line 10-10 in FIG. 9.

FIG. 11 is an exploded view of the cross-sectional view of FIG. 10.

FIG. 12 is an isometric view of another embodiment of a pipe adapter according to certain aspects of the disclosure.

FIG. 13 is a cross-sectional view of the pipe adapter of FIG. 12 taken along line 13-13 in FIG. 12.

FIG. 14 is an exploded view of the cross-sectional view of FIG. 13.

FIG. 15 is an isometric view of another embodiment of a pipe adapter according to certain aspects of the disclosure.

FIG. 16 is a cross-sectional view of the pipe adapter of FIG. 15 taken along line 16-16 in FIG. 15.

FIG. 17 is an exploded, pre-manufacturing view of the cross-sectional view of FIG. 15.

FIG. 18 is a cross-sectional view of a first step of a method of forming a pipe adapter as in FIG. 15.

FIG. 19 is a cross-sectional view of a second step of a method of forming a pipe adapter as in FIG. 15.

FIG. 20 is a cross-sectional view of a third step of a method of forming a pipe adapter as in FIG. 15.

FIG. 21 is a cross-sectional view of a fourth step of a method of forming a pipe adapter as in FIG. 15.

FIG. 22 is a cross-sectional view of a fifth step of a method of forming a pipe adapter as in FIG. 15.

### DETAILED DESCRIPTION

Detailed reference will now be made to the drawings in which examples embodying the present disclosure are shown. The detailed description uses numeral and letter designations to refer to features in the drawings. Like or similar designations in the drawings and description have been used to refer to like or similar parts of the disclosure.

The drawings and detailed description provide a full and enabling description of the disclosure and the manner and process of making and using it.

Each embodiment is provided by way of explanation of the subject matter not limitation thereof. In fact, it will be apparent to those skilled in the art that various modifications and variations may be made to the disclosed subject matter without departing from the scope or spirit of the disclosure. For instance, features illustrated or described as part of one embodiment may be used with another embodiment to yield a still further embodiment.

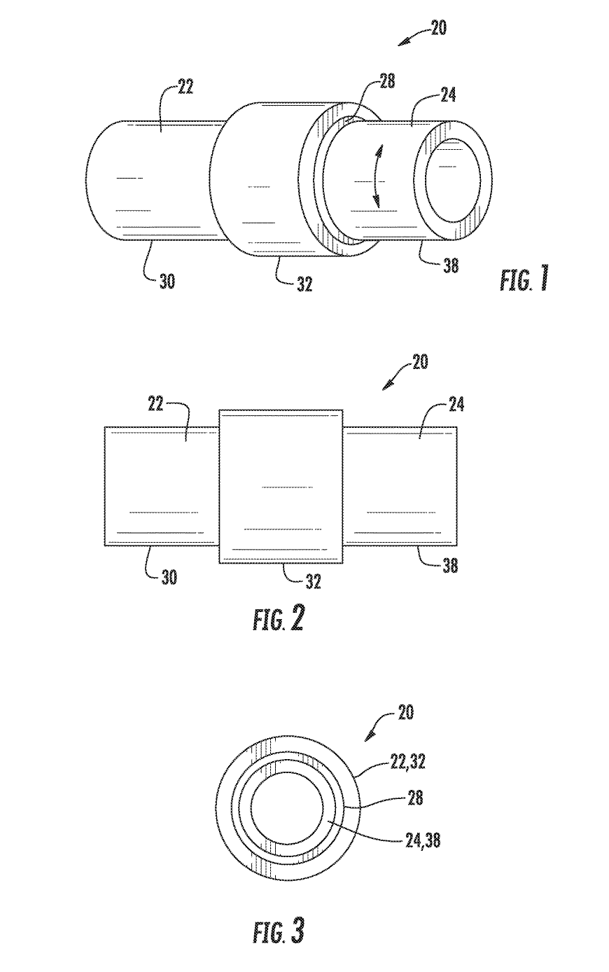

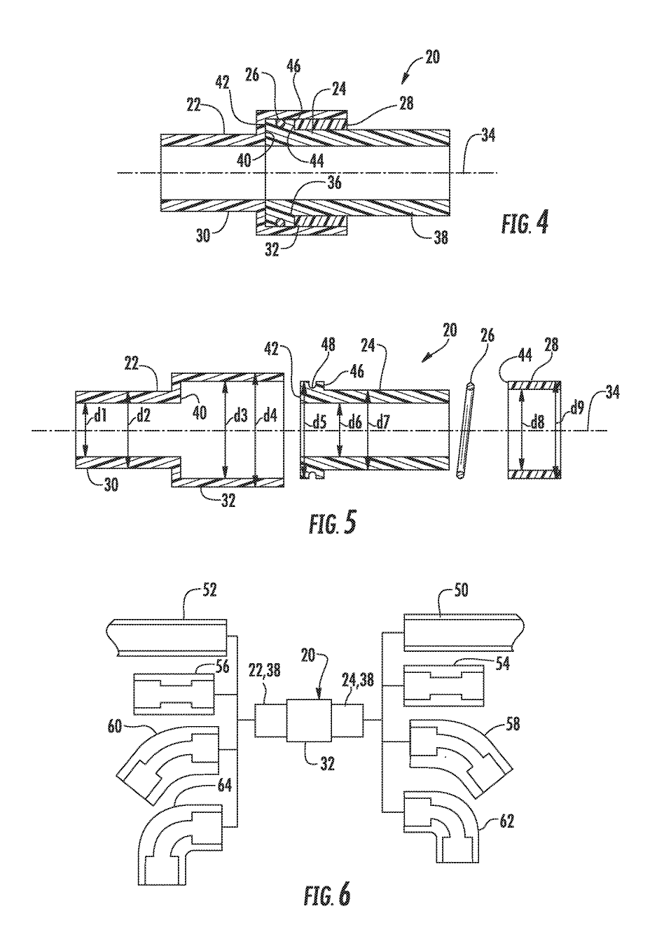

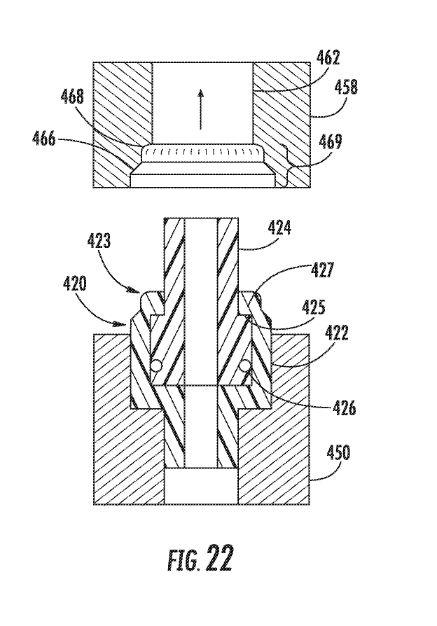

Generally speaking, FIGS. 1-17 depict examples of pipe adapters that can be used to connect various types of piping or connectors while allowing relative rotation, and FIGS. 18-22 depict one example of a method for forming one such pipe adapter. The piping, like that in Applicant's U.S. patent application Ser. No. 15/166,466, filed May 27, 2016, can be used with liquids, gases and electrical wiring or any other suitable application. A first embodiment of such a pipe adapter 20 is shown in FIGS. 1-6. As illustrated, pipe adapter 20 includes first tubular element 22, second tubular element 24, annular sealing member 26 and annular securing member 28. Components 22, 24 and 28 may be formed of PVC material, but plastics such as CPVC, ABS, PE, PEX and still others could also be employed. Annular sealing member 26 is preferably an O-ring formed of a rubber or thermoplastic such as Nitrile Butadiene Rubber (NBR), Hydrogenated Nitrile Butadiene Rubber (HNBR), Carboxylated Nitrile Butadiene Rubber (XNBR), Silicone Rubber (SIR), Fluoroelastomer (FKM), etc.

The choice of material for components 22-28 can be readily selected by one skilled in the art depending on the characteristics (e.g., temperatures, pressures, environment, chemical exposure, etc.) of the application in which the pipe adapter will be deployed. It should therefore be understood that the present disclosure is not limited to particular examples of materials noted above.

As illustrated, first tubular element 22 has a first portion 30 and a second portion 32 adjacent each other along axis 34. First portion 30 has an inner diameter d₁ and an outer diameter d₂. Second portion 32 has an inner diameter d₃ and an outer diameter d₄ both larger than their corresponding inner and outer diameters d₁,d₂ of first portion 30. Second portion 32 defines a socket 35 bounded by shoulder 40 and the walls of inner diameter d₃.

Second tubular element 24 has a first portion 36 and a second portion 38 axially adjacent the first portion. First portion 36 defines a distal end 42 sized for insertion into socket 35. First portion 36 also has a radially extending stop 46 spaced from distal end 42. Distal end 42 has a diameter d₅ just smaller than d₃ of socket 35 so that the first and second tubular elements 22,24 are readily slid together along axis 34 while generally maintaining alignment due to the mating cylindrical shapes at the d₃/d₅ interface. Thus, during assembly of pipe adapter 20, as shown in FIGS. 4 and 5, first portion 36 of second tubular element 24 is slid into second portion 32 (i.e., socket 35) of first tubular element 22 until distal end 42 hits shoulder 40.

Annular sealing member 26 is located between first portion 36 of second tubular element 24 and second portion 32 of first tubular element 22. Annular sealing member 26 provides a seal preventing axial flow along the d₃/d₅ interface between tubular elements 22,24. A channel may be provided in one or both of the d/3/d5 surfaces to receive annular sealing member 26. As illustrated, one such channel 48 is provided in first portion 36 of second tubular element. If desired, additional sealing members could also or alternatively be provided along the d/3/d5 interface or along the shoulder 40/distal end 42 interface to seal between first and second tubular elements 22,24.

Annular securing member 28 is has an internal diameter d₈ and an external diameter d₉. Internal diameter d₈ is sized just larger than external diameter d₇ of second tubular element 24. External diameter d₉ of annular securing member 28 is sized just smaller than internal diameter d₃ of second portion 32 first tubular element 22. Therefore, after the first and second tubular elements 22,24 are slid together (with annular sealing member 26 in place) annular securing member 28 can be slid onto second tubular element 24 within socket 35. Annular securing member 28 has a distal end 44 that abuts stop 46 on first portion 36 of second tubular element 24 when annular securing member 28 is fully installed. It may be preferable, as shown, that end 45 of annular securing element 28 and end 47 of second portion 32 of first tubular element 22 are radially aligned after insertion (see FIGS. 1, 2 and 4). At this point, each of first tubular element 22, second tubular element 24 and annular securing member 28 are all relatively rotatable relative to each other around axis 34.

After assembly, annular securing member 28 is fixed within socket 35 of first tubular element 22, for example, by at least one of an adhesive, an epoxy, hot welding, ultra-sonic welding, mating threads, and/or a snap fit. Annular securing member 28 is preferably not fixed to second tubular element 24. After assembly and fixing of annular securing member 28 within socket 35, distal end 44 of annular securing member 28 contacts stop 46 on second tubular element 24 to secure second tubular element 24 axially relative to first tubular element 22 while also allowing second tubular element 24 to rotate relative to first tubular element 22 and annular securing member 28.

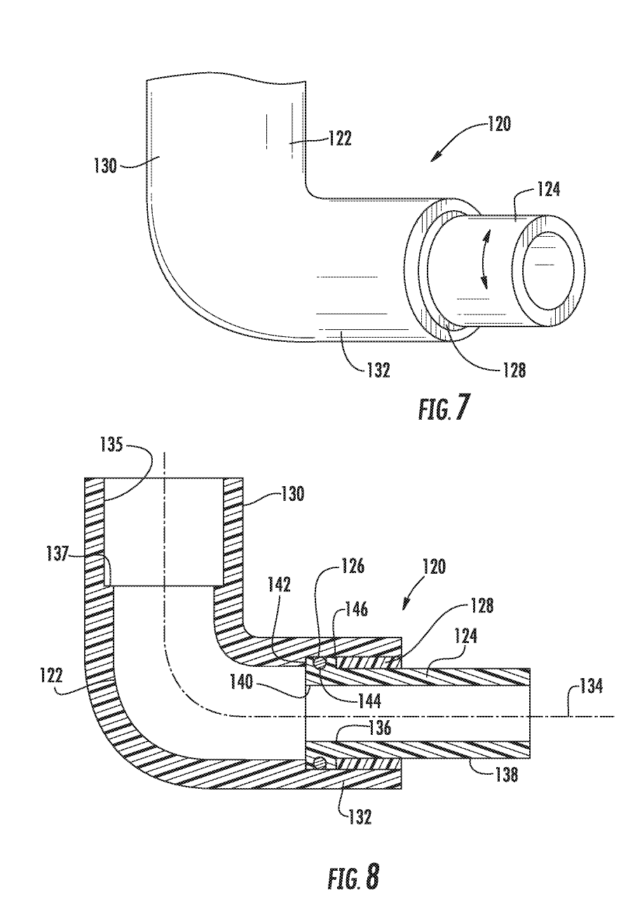

Adapter 20 can be used to connect various types of pipes and connectors, as schematically illustrated in FIG. 6. For example, pipes 50, 52, straight connectors 54, 56, angled connectors 58,60, right-angled connectors 62,64, and other piping elements can be attached to portions 30 and 38. Adapter 20 has particular utility where one or two angled connectors are employed, or where straight connectors or pipes are connected to pipes angled further on. In such case the rotatability of the element attached to portion 38 relative to the element attached to portion 30 allows for some adjustability. Thus, the additional elements can be fixed to portions 30 and 38, while leaving them relatively rotatable while further elements are attached along the layout. If a rigid layout is desired, after the layout is completed, second tubular element 24 can be permanently fixed (e.g., by an epoxy, weld or other ways) to annular securing element 28. Alternatively, if desired, the rotatability may be maintained permanently by not fixing together such parts.

FIGS. 7 and 8 depict another embodiment of a pipe adaptor 120 in which like or similar elements are identified with like or similar reference numerals. For brevity, all depicted elements of pipe adaptor 120 are not described herein; please refer to the description above.

Pipe adaptor 120 includes a first tubular element 122, a second tubular element 124, an annular sealing member 126 and an annular securing member 128. The latter three parts are essentially similar to the corresponding parts of pipe adaptor 20 and thus need not be discussed in further detail.

However, first tubular element 122 differs from first tubular element 22 in that element 122 has a first portion 130 formed with a socket 135 having a shoulder 137. Socket 135 is sized for receiving a pipe therein. Alternatively, a second set of elements 124, 1426 and 128 may be inserted into socket 135 in a similar fashion. To provide two elements 124 rotatable relative to element 122.

Note the right angle turn of axis 134 between socket 135 and second portion 138 of second tubular element 124. As illustrated, first tubular element 122 incorporates the structure and functionality of a right-angle connector within the adapter itself. It should be understood that path of axis 134 may be straight (providing a linear connector function) or angled at any desired direction (i.e., 30 degrees, 45 degrees, 60 degrees, 90 degrees, etc.) to which the first tubular element 122 can be manufactured. Thus, pipe adapter 120 provides the benefits of pipe adapter 20 above with respect to the rotational adjustability of parts. Pipe adapter 120 also provides a compact assembly including an on-board socket so that, for example, a connector such as connectors 54-62 with two sockets need not also be employed with adapter 20 when a socket is desired at a location adjacent the adapter.

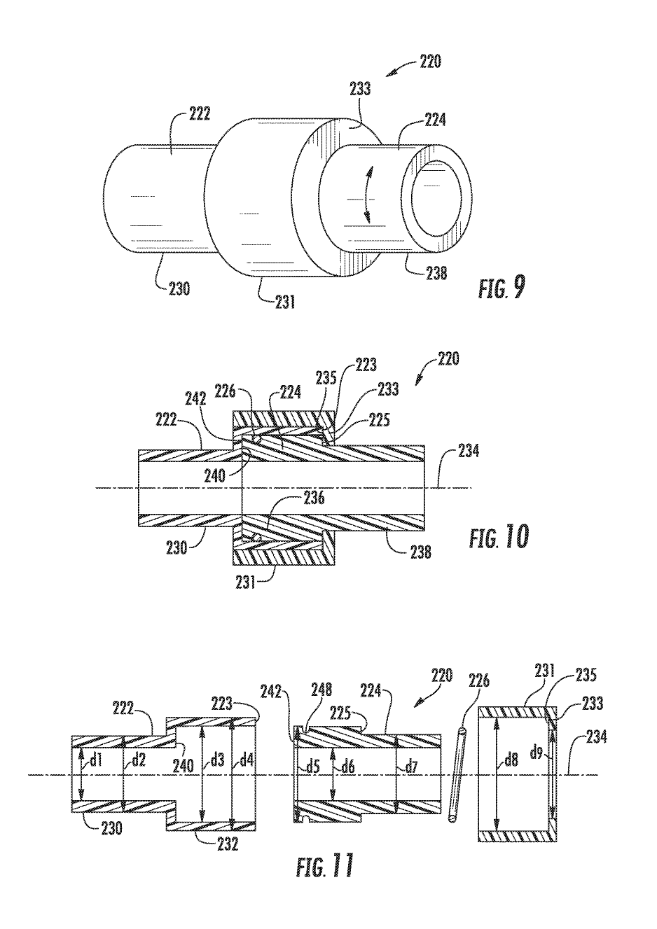

FIGS. 9-11 show another alternative pipe adapter 220. As shown, pipe adapter 220 includes a first and second tubular elements 222, 224 along a central axis 234. First tubular element first portion 230 and second portion 232 are separated by a radially-extending shoulder 240 and a distal end has a stop 223. First portion 230 has an inner diameter d₁ and an outer diameter d₂; second portion 232 has an inner diameter d₃ and an outer diameter d₄. Second tubular element has a first portion 236 and second portion 238, the first portion having a distal end 242 that abuts shoulder 240 and having a radially extending stop 225. First portion 236 has an inner diameter d₆ and an outer diameter d₅, just smaller than d₃; second portion 238 has an inner diameter d₆ and an outer diameter d₇.

An annular sealing member 226 is located in a channel 248 between first portion 236 of second tubular element 224 and second portion 232 of first tubular element 222 to an axial seal therebetween. Annular sealing member 226 may be, for example, an O-ring or other suitable circular seal allowing rotation between sealed surfaces.

An annular securing member 231 is disposed around and fixed to second portion 232 of the first tubular element 222 for movement therewith. An inner diameter d₈ of annular securing member 231 is just larger than d₄ of first tubular member 220 so that the parts 222, 224 and 231 can be axially joined as shown in FIG. 10. An adhesive, weld, etc. may be located so as to bond the surfaces defined by d₄ and d₈. Annular securing member 231 has a flange portion 233 with an inner diameter d₉ just larger than d₇. Annular securing member 231 also has a surface 235 contacting stops 223,225 to thereby secure second tubular element 224 axially relative to first tubular element 222 while also allowing second tubular element 224 to rotate relative to first tubular element 222 and annular securing member 226.

The structure of FIG. 9-11 could also be described as providing a first tubular element 222 defining a socket (d₃), a second tubular element portion (d₅) insertable into the socket and defining a radially-extending stop 225. An annular sealing member 226 is located between first and second tubular elements to provide an axial seal therebetween. An annular securing member 231 is disposed around and fixed to a second portion 232 of the first tubular element 220 for movement therewith, the annular securing member 231 having a flange portion 233 contacting stop 225 to secure the second tubular element 224 axially relative to the first tubular element 222 while also allowing the second tubular element to rotate relative to the first tubular element and annular securing member 231.

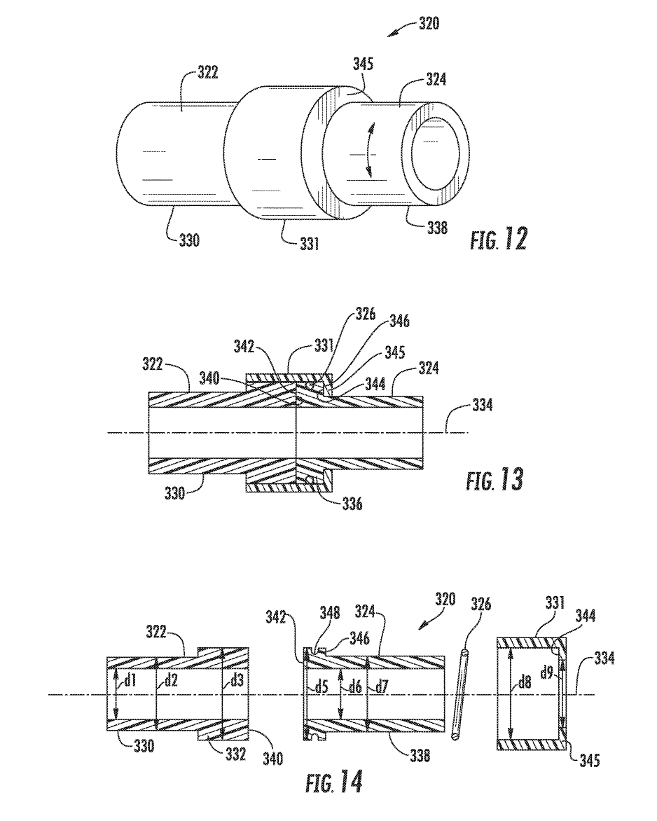

FIGS. 12-14 show another alternative pipe adapter 320. As shown, pipe 320 adapter includes a first tubular element 322, a second tubular element 324 along a central axis 334. First tubular element 322 has a first portion 330, a second portion 332, and a radially-extending shoulder 340 at the distal end of the second portion. First portion 322 has an inner diameter d₁ and an outer diameter d₂; second portion 324 has an inner diameter d₁ an outer diameter larger d₃. Second tubular element 324 has a first portion 336 and a second portion 338 portion. First portion 336 has an inner diameter d₆ substantially equal to d₁, and an outer diameter d₅ substantially equal to d₃. Second tubular element 324 first portion 336 has a distal end 342 that abuts the shoulder 340, and also has a radially-extending stop 346.

An annular securing member 331 is disposed around and fixed to the second portion 332 of the first tubular element 322 for movement therewith. An inner diameter d₈ of annular securing member 331 is just larger than d₃ and d₅ of first and second tubular members 322, 324 so that the parts 322, 324 and 331 can be axially joined as shown in FIG. 13. An adhesive, weld, etc. may be located so as to bond the surfaces defined by d₃ and d₈. Annular securing member 331 has a flange portion 345 with an inner diameter d₉ just larger than d₇ and a surface 344 contacting the stop 346 to secure second tubular element 324 axially relative to first tubular element 322 while also allowing second tubular element 324 to rotate relative to first tubular element 322 and annular securing member 331.

An annular sealing member 326, which may be for example an O-ring or other circular seal, is located in a channel 348 between first portion 326 and annular securing member 331 and providing an axial seal therebetween.

FIGS. 15-17 show another alternative pipe adapter 420. As shown, pipe adapter 420 includes a first and second tubular elements 422, 424 along a central axis 434. First tubular element first portion 430 and second portion 432 are separated by a radially-extending shoulder 440 and a distal end of the second portion has a securing portion 423. First portion 430 has an inner diameter d1 and an outer diameter d2; second portion 432 has an inner diameter d3 and an outer diameter d4. Second tubular element 424 has a first portion 436 and second portion 438, the first portion having a distal end 442 that abuts shoulder 440 and has a radially extending stop 425. First portion 436 has an inner diameter d6 and an outer diameter d5, just smaller than d3; second portion 438 has an inner diameter d6 and an outer diameter d7.

It should be understood that first tubular element 422 of pipe adapter 420 or others above may be formed with a bend, as in first tubular element 122 of the embodiment of FIGS. 7-8. Thus, first tubular element 422 (and axis 434) may include a bend at any desired angle (e.g., 30 degrees, 45 degrees, 60 degrees, 90 degrees, etc.). Thus, discussion of axial directions herein, include directions along axes that include a bend, such as in FIG. 8. As noted above, the bends should not be located at areas which would compromise the connection and sealing between the first and second tubular elements 422,424. It would also be possible, additionally or alternatively, to include such a bend in second tubular element 424. Pipe adapter 420 can thus have the combined functionality of an angled connector and a rotatable, sealed adapter. Also, use of two such angled pipe adapters 420 (whether identical or different) in one assembly, either connected together or with a straight pipe portion between them, would provide even further adjustability with more degrees of freedom for installation of a piping system. All such subject matter is within the scope of the present disclosure.

An annular sealing member 426 is located in a channel 448 between first portion 436 of second tubular element 424 and second portion 432 of first tubular element 422 to an axial seal therebetween. Annular sealing member 426 may be, for example, an O-ring or other suitable circular seal allowing rotation between sealed surfaces.

Securing portion 423 is formed integrally with second portion 432 of the first tubular element 422 and has a flange portion 427 contacting stop 425 to secure second tubular element 424 axially relative to first tubular element 422 while also allowing the second tubular element to rotate relative to the first tubular element. Securing portion 423 extends from second portion 432 of the first tubular element towards (and may be in contact with) an outer surface 429 of second portion 438 of second tubular member 424.

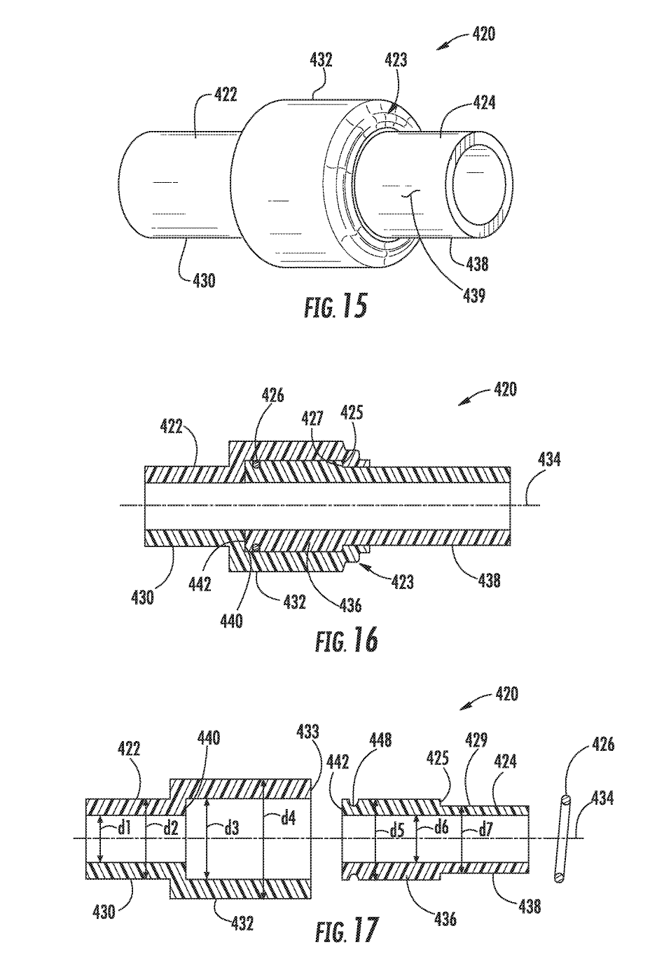

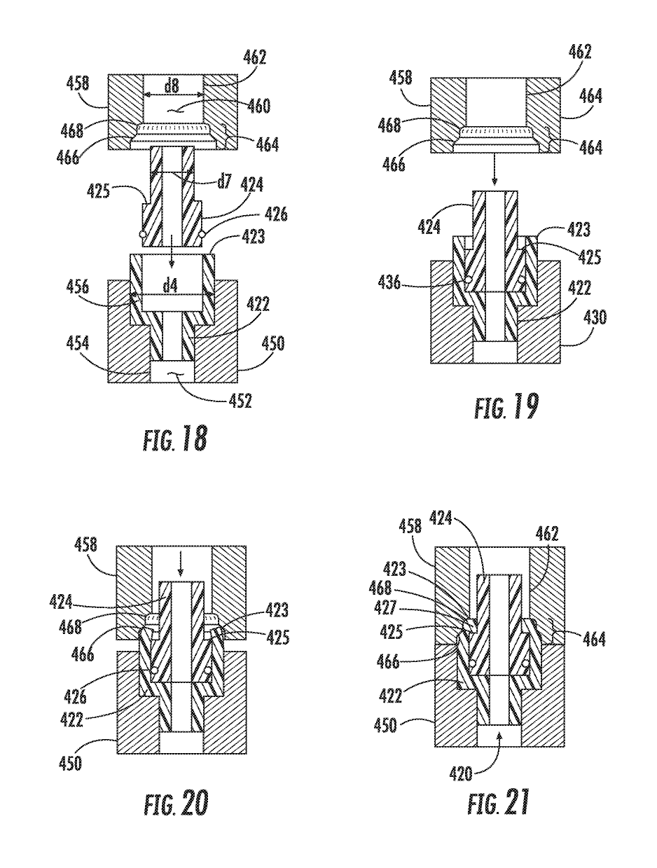

Note that FIGS. 15 and 16 show pipe adapter 420 in a post-manufacturing state, while the exploded view of FIG. 17 shows pipe adapter 420 in a pre-manufacturing state with securing portion 423 not yet formed (molded radially inwardly) into flange portion 427. Such structure and one method for manufacturing it will be described below.

The structure of FIG. 15-17 could also be described as providing a first tubular element 422 defining a socket (d3), a second tubular element 424 portion (d5) insertable into the socket and defining a radially-extending stop 425. An annular sealing member 426 is located between first and second tubular elements to provide an axial seal therebetween. Securing portion 423 includes a flange portion 427 that contacts stop 425 to secure second tubular element 424 (within the socket) axially relative to first tubular element 422 while also allowing the second tubular element to rotate relative to the first tubular element.

One possible method of forming pipe adapter 420 is shown in FIGS. 18-22. As shown therein, first tubular element 422 is placed into a holder 450 having an opening 452 therein sized for receipt of the first tubular element. As illustrated, holder 450 is a metallic element, and opening 452 has two coaxially oriented portions 454, 456 of differing diameter corresponding to the size of first tubular element 422. However, variations such as other shapes of holders, holders with multiple discrete elements, etc., may be employed.

Annular sealing member 426 is placed into channel 448 in second tubular element 424, although the channel and annular sealing member could initially be placed in the socket portion (d3) of first tubular element 422.

Second tubular element 424 is then axially inserted into the socket portion of first tubular element 422 (see FIGS. 18-19) so that annular sealing member 426 provides an axial seal between the first and second tubular elements.

Then, bending of securing portion 423 of first tubular element 422 over stop portion 425 of second tubular element 424 to form flange portion 427 is performed. After such bending, flange portion 427 contacts stop portion 425 to secure second tubular element 424 axially relative to first tubular element 422 while also allowing the second tubular element to rotate relative to the first tubular element.

The bending may be performed by a reciprocally-moving heated mold element 458 that moves downward to heat and form securing portion 423 so as to change from the pre-molded shape of FIGS. 17 and 19 to the finished shape of FIGS. 15 and 22, and then moves upward so that the formed pipe adapter 420 may be ejected from holder 450.

Mold element 458 preferably only, or at least substantially only, contacts portions of first tubular element 422 desired to be heated and formed. Thus, mold element 458 may have a central opening 460 with a first part 462 with a diameter (d8) greater than that (d7) of second portion 438 of second tubular element 424, and a second part 464 with a diameter (which may be a varying diameter along the axial direction) less than that (d4) of second portion 432 of first tubular member 422.

The varying diameter of second part 464 of central opening 460 of mold element 458 is provided to help urge the securing portion radially inwardly to transform securing portion 423 into flange portion 427. Second part 464 may therefore include a radially tapered portion 466 that spans in diameter greater and less than d4 so as to contacts the outer edge of securing portion 423 (d4) to move it radially inwardly as mold element 458 move down axially. A distal portion 468 on second part 464 provides a desired shape for molding securing portion 423/flange portion 427 around stop 425 and second portion 438 of second tubular member 424. As shown, 468, distal portion 468 is smaller in circumference than tapered portion 466.

The mold element 458 should be heated for a period of time and to a temperature necessary to bend and form the securing portion 423 material utilized for first tubular element 422 as described above without compromising the structural integrity of the rest of the pipe adapter 420, it's axial alignment, it's rotatability, it's seal, etc. Thus, using an aluminum mold element, with an outer wall width of about 0.13 inches of PVC at second part 432, heating mold element 458 to about 315 F and contacting second part 432 for about 30-45 seconds with sufficient downward force to form securing portion 423 into the desired shape is sufficient. However, one skilled in the art can select temperatures, contact times, contact forces, for pipe adapters of different materials, dimensions, etc.

The disclosed pipe adapters 20, 120, 220, 320, 420 therefore provide improved efficiency and flexibility in installation of piping systems. The pipe adapters can be mixed and matched with various off the shelf parts, and can be made in various standard and nominal pipe sizes. The pipe adapters can be sold pre-made (with rotatability) or can be sold in kits including parts for one adapter, or in kits including multiple units of each part with multiple optional parts (such as connectors 54-62), and or with straight or angled connector-like parts or pipes with built in sockets 135 like part 122. The rotatable adapters 20, 120, 220, 320, 420 provide relief from stresses and strains caused by seismic activity. Thus, the present disclosure provides a number of different ways in which technicians working in the field can benefit, save time, work though misalignments or changes in the field on the fly, and that can reduce failures in case of seismic activity.

While preferred embodiments of the invention have been described above, it is to be understood that any and all equivalent realizations of the present invention are included within the scope and spirit thereof. Thus, the embodiments depicted are presented by way of example only and are not intended as limitations upon the present invention. Thus, while particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

I claim:

1. A pipe adapter comprising:
a first tubular element defining a central axis and having a first portion, a second portion axially adjacent the first portion, a securing portion adjacent an end of the second portion opposite the first portion, and a radially-extending shoulder between the first portion and second portion, the first portion having an inner diameter and an outer diameter, the second portion having an inner diameter larger than the first portion inner diameter and an outer diameter larger than the first portion inner diameter;
a second tubular element defining a central axis and having a first portion and a second portion axially adjacent the first portion, the first portion of the second tubular element having an inner diameter and an outer diameter just smaller than the inner diameter of the second portion of the first tubular element, the second tubular element first portion having a distal end that abuts the shoulder and having a radially extending stop;
an annular sealing member located between the first portion of the second tubular element and the second portion of the first tubular element and providing an axial seal therebetween; and
the securing portion being formed integrally with the second portion of the first tubular element and having a flange portion contacting the stop to secure the second tubular element axially relative to the first tubular element while also allowing the second tubular element to rotate relative to the first tubular element.

2. The pipe adapter of claim 1, wherein at least one of the first portion of the first tubular element and the second portion of the second tubular element are each sized for attachment to a socket of a respective pipe connector.

3. The pipe adapter of claim 2, wherein the respective pipe connectors are selected from straight pipe connectors, angled pipe connectors and right-angled pipe connectors.

4. The pipe adapter of claim 1, wherein at least one of the first portion of the first tubular element and the second portion of the second tubular element are each sized for attachment within an end opening of a respective pipe.

5. The pipe adapter of claim 1, wherein the annular sealing member includes an O-ring.

6. The pipe adapter of claim 1, wherein the first portion of the second tubular element defines a channel for positioning the annular sealing member.

7. The pipe adapter of claim 1, wherein the securing portion extends from the second portion of the first tubular element toward an outer surface of the second portion of the second tubular element.

8. The pipe adapter of claim 7, wherein the securing portion has an outer circumferential shape with a first portion of a first diameter at a distal end and a slanted portion of increasing diameter adjacent the first portion.

9. A pipe adapter comprising:
a first tubular element having a first portion, a second portion axially adjacent the first portion, and a securing portion adjacent an end of the second portion opposite the first portion, the second portion defining a socket;
a second tubular element having a first portion and a second portion axially adjacent the first portion, the first portion defining a distal end sized for insertion into the socket and having a radially extending stop;
an annular sealing member located between the first portion of the second tubular element and the second portion of the first tubular element and providing an axial seal therebetween; and
the securing portion being formed integrally with the second portion of the first tubular element and having a flange portion contacting the stop to secure the second tubular element axially relative to the first tubular element while also allowing the second tubular element to rotate relative to the first tubular element.

10. The pipe adapter of claim 9, wherein at least one of the first portion of the first tubular element and the second portion of the second tubular element are each sized for attachment to a socket of a respective pipe connector.

11. The pipe adapter of claim 10, wherein the respective pipe connectors are selected from straight pipe connectors, angled pipe connectors and right-angled pipe connectors.

12. The pipe adapter of claim 9, wherein at least one of the first portion of the first tubular element and the second portion of the second tubular element are each sized for attachment within an end opening of a respective pipe.

13. The pipe adapter of claim 9, wherein the annular sealing member includes an O-ring.

14. The pipe adapter of claim 9, wherein the first portion of the second tubular element defines a channel for positioning the annular sealing member.

15. The pipe adapter of claim 9, wherein the securing portion extends from the second portion of the first tubular element toward an outer surface of the second portion of the second tubular element.

16. The pipe adapter of claim 9, wherein the securing portion has an outer circumferential shape with a first portion of a first diameter at a distal end and a slanted portion of increasing diameter adjacent the first portion.

17. A method of forming a pipe adapter comprising:
placing into a holder a first tubular element having a first portion, a second portion axially adjacent the first portion, and a securing portion adjacent an end of the second portion opposite the first portion, the second portion defining a socket;
placing an annular sealing member into a channel in one of the socket or a first end of a second tubular element;
placing into the socket the second tubular element so that the annular sealing member provides an axial seal between the first and second tubular elements, the second tubular element having a second portion axially adjacent the first portion, the first portion defining a radially extending stop; and
bending the securing portion so as to form a flange portion contacting the stop to secure the second tubular element axially relative to the first tubular element while also allowing the second tubular element to rotate relative to the first tubular element.

18. The method of claim 17, wherein the bending step includes moving a heated mold into contact with the second tubular element to heat and compress radially inwardly the securing portion.

19. The method of claim 18, wherein the bending step includes using the heated mold including a radially tapered portion that contacts the securing portion to move the securing portion radially inwardly.

20. The method of claim 19, wherein the heated mold further includes a shaping portion axially spaced from the radially tapered portion for shaping a distal end of the securing portion.
